(19) United States
(12) Patent Application Publication
(10) Pub. No.: US 2021/0090789 A1
(43) Pub. Date: Mar. 25, 2021

(54) INDUCTOR STRUCTURE WITH MULTIPLE WINDINGS WITH UNCOUPLED MAGNETIC FIELDS

(71) Applicant: FORD GLOBAL TECHNOLOGIES, LLC, Dearborn, MI (US)

(72) Inventor: Srikanthan SRIDHARAN, Dearborn, MI (US)

(21) Appl. No.: 16/576,382

(22) Filed: Sep. 19, 2019

(51) Int. Cl. H01F 27/30; H01F 27/255

(52) U.S. Cl. CPC H01F 27/30; H01F 27/255

(57) ABSTRACT

A dual coil inductor apparatus is disclosed that includes a core, and inner coil, and an outer coil. The core may be formed of a ferromagnetic powder material in a one-piece toroidal shape. The inner coil winding is embedded within the core. The outer coil winding is wrapped radially around the outside of the core. A three-coil inductor apparatus is also disclosed that includes a core having common origin point with a first core loop lying in a x/y plane, a second core loop lying in a y/z plane, and a third core loop lying in a x/z plane. Windings around the core loops create magnetic fields in three planes when current is provided to the windings. The magnetic fields are orthogonal to each other and provide magnetically uncoupled inductors that may be provided with current separately or combined in series or parallel to potentially provide seven levels of induction.

### TECHNICAL FIELD

This disclosure relates to magnetic core inductors having multiple windings with magnetic fields that are orthogonal to each other to provide magnetically uncoupled inductors.

### BACKGROUND

Conventional magnetic core inductors consist of a laminated or powder metal core material with windings wound on the outside of the core. Such inductors are designed to provide the required inductance characteristics for a single inductive output. Additional inductors are required to provide different inductance values.

This disclosure is directed to solving the above problems and other problems as summarized below.

### SUMMARY

According to one aspect of this disclosure, a dual coil uncoupled inductor apparatus is disclosed that includes a core, and inner coil, and an outer coil. The core may be formed of a ferromagnetic powder material in a one-piece toroidal shape. The inner coil winding is disposed in an X/Y plane within the core and embedded within the powder material. The outer coil winding is wrapped around the outside of the core with windings being radially wrapped around the core.

According to another aspect of this disclosure, a three-coil inductor apparatus is disclosed that has mutually perpendicular magnetic fields. The three-coil inductor includes a core with a first core loop lying in a x/y plane, a second core loop lying in a y/z plane, and a third core loop lying in a x/z plane, wherein the x/y plane, the y/z plane, and the x/z plane have a common origin point. A first winding around the first core loop creates an x/y magnetic field when current is provided to the first winding, a second winding around the second core loop creates a y/z magnetic field when current is provided to the second winding, and a third winding around the third core loop creates an x/z magnetic field when current is provided to the third winding.

According to another aspect of this disclosure a three-coil inductor apparatus is disclosed that comprises:
a core including

a first portion having a first shared leg lying on an x-axis, a second shared leg lying on a y-axis, and a first linking portion extending in an x/y plane between distal ends of the first and second shared legs;

a second portion including the second shared leg lying on the y-axis and a third shared leg lying on the z-axis, a second linking portion extending in a y/z plane between distal ends of the second and third shared legs; and

a third portion including the first shared leg lying on the x-axis and a third shared leg lying on the z-axis, a third linking portion extending in a x/z plane between distal ends of the first and third shared legs; and wherein the x-axis, the y-axis, and z-axis extend from a common origin point;
a first winding wrapped around the first portion and the first linking portion;
a second winding wrapped around the second portion and the second linking portion; and
a third winding wrapped around the third portion and the third linking portion, wherein the windings are selectively provided with current to create a magnetic field in the planes the first, second, and third portions lie within, wherein the windings may be provided with current separately or combined in series or parallel.

The above aspects of this disclosure and other aspects will be described below with reference to the attached drawings.

### BRIEF DESCRIPTION OF THE DRAWINGS

FIG. 1 is a schematic diagram illustrating an example of an electrified vehicle.

FIG. 2 is a diagrammatic plan view of an inductor apparatus having an inner winding embedded in a core and an outer winding radially wrapped around the core.

FIG. 3 is a diagrammatic perspective view of the inductor apparatus of FIG. 2.

FIG. 4A is a cross-section view taken along the line 4A-4A in FIG. 2.

FIG. 4B is a cross-section of a circular toroid core similar to the cross-section shown in FIG. 4A.

FIG. 5 is a diagrammatic perspective view of an inductor apparatus having three induction coils wound on a core including three shared legs including arcuate linking portions that create three mutually perpendicular magnetic fields.

FIG. 6 is a three-dimensional graph of the winding fields created by the inductor apparatus shown in FIG. 5.

FIG. 7 is a diagrammatic perspective view of an inductor apparatus having three induction coils wound on a core including three shared legs including rectilinear linking portions that create three mutually perpendicular magnetic fields.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be used in particular applications or implementations.

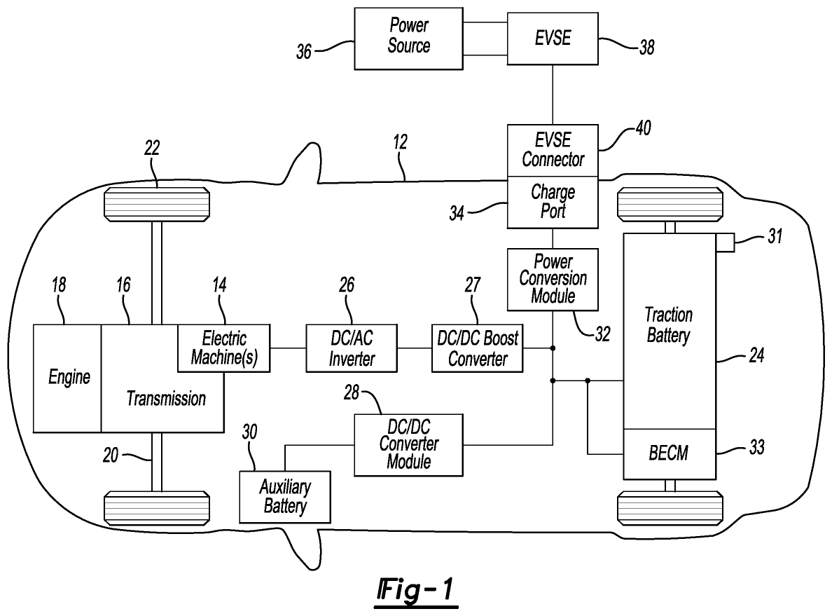

FIG. 1 illustrates a schematic diagram illustrating an example of an electrified vehicle. In this example, the electrified vehicle is a plug-in electric vehicle referred to as a vehicle 12 herein. The vehicle 12 may include one or more electric machines 14 mechanically connected to a hybrid transmission 16. Each of the electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to wheels 22. The electric machines 14 may provide propulsion and deceleration capability when the engine 18 is turned on or off. The electric machines 14 may also operate as generators and provide fuel economy benefits by recovering energy that would normally be lost as heat in the friction braking system. The electric machines 14 may also provide reduced pollutant emissions since the vehicle 12 may be operated in electric mode under certain conditions.

A traction battery 24 stores energy that may be used by the electric machines 14. The traction battery 24 typically provides a high voltage DC output from one or more battery cell arrays, sometimes referred to as battery cell stacks, within the traction battery 24. The battery cell arrays may include one or more battery cells. The traction battery 24 is electrically connected to one or more power electronics modules 26 through one or more contactors (not shown). The one or more contactors may isolate the traction battery 24 from other components when opened and may connect the traction battery 24 to other components when closed. The DC/AC inverter 26 is also electrically connected to the electric machines 14 and provides an ability to bi-directionally transfer electrical energy between the traction battery 24 and the electric machines 14. For example, a typical traction battery 24 may provide a DC voltage while the electric machines 14 may require a three-phase AC voltage to function. The DC/AC inverter 26 may convert the DC voltage to a three-phase AC voltage as required by the electric machines 14. In a regenerative mode, the DC/AC inverter 26 may convert the three-phase AC voltage from the electric machines 14 acting as generators to the DC voltage required by the traction battery 24. The inductor can also be applied to a DC/DC boost converter 27 that is optional but may be used to boost the traction battery voltage to a higher voltage level. For a pure electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. The DC/DC power converter module may function as a boost converter capable of providing multiple levels of inductive output for either plug-in or hybrid electric vehicles. In a typical vehicle, the low-voltage systems are electrically connected to an auxiliary battery 30 (e.g., a twelve-volt battery).

A battery electrical control module (BECM) 33 may be in communication with the traction battery 24. The BECM 33 may act as a controller for the traction battery 24 and may also include an electronic monitoring system that manages temperature and charge state of each battery cell of the traction battery 24. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36 such as an electrical outlet. The external power source 36 may be electrically connected to an electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The charge connector 40 may have pins that mate with corresponding recesses of the charge port 34.

The various components discussed above may have one or more associated controllers to control and monitor the operation of the components. The controllers may communicate via a serial bus (e.g., a controller area network (CAN)) or via discrete conductors.

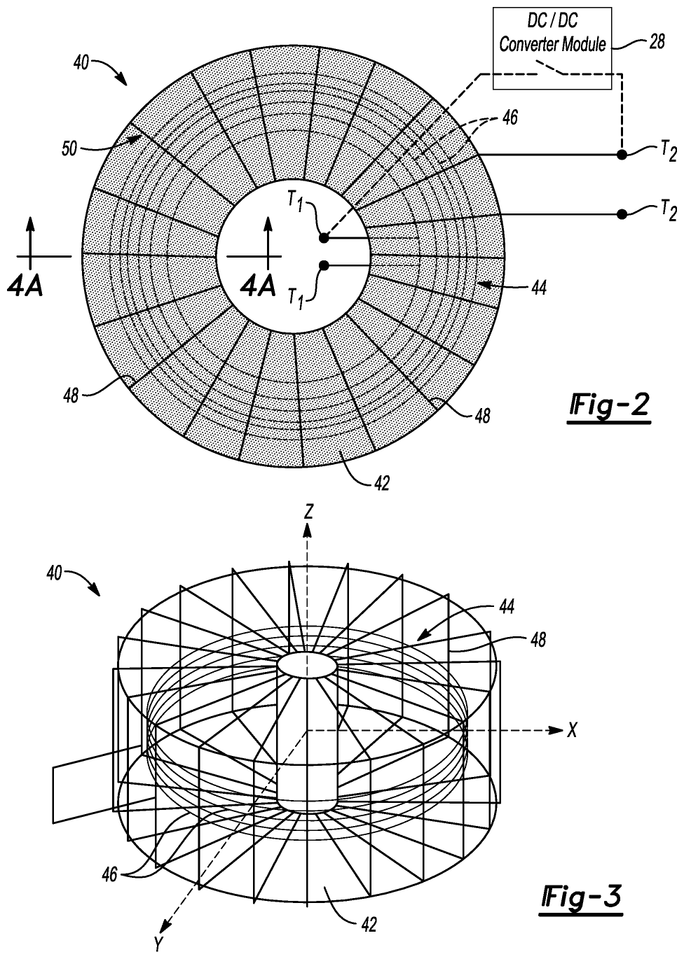

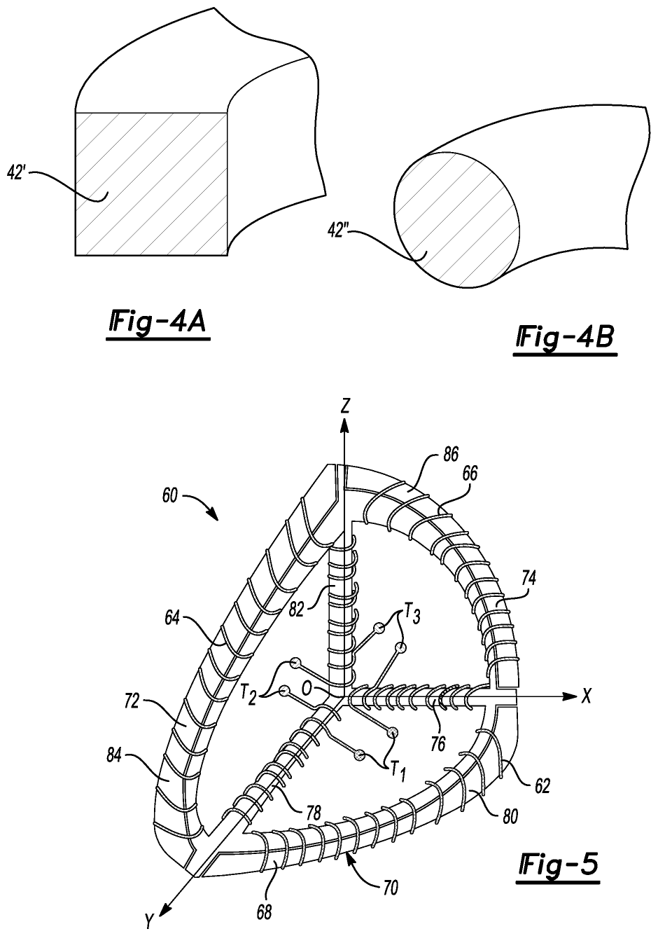

Referring to FIGS. 2 and 3, one embodiment of an inductor 40 is illustrated that can be used to provide three different levels of inductive outputs. The inductor 40 includes a ferromagnetic core 42 that is formed by compressed powdered metal in the form of a toroidal shape. The toroidal shape may be a toroid having a polygonal or a circular radial section. An inner coil 44 including a plurality of inner windings 46 is embedded inside the core 42 when the core 42 is formed from the powdered metal in a powdered metal forming operation wherein the powdered metal is compressed and then sintered. One advantage of embedding the inner coil in the powder forming the core 42 is that the inner windings 46 are in direct contact with the core material so there is better thermal conductivity between the inner windings 46 and the core 42.

The inner coil 44 is connected through external terminals T₁ to the DC/DC converter module 28 or the power electronics module 26, as shown in FIG. 1. EVSE 38. The terminals T₁ are accessible outside the core 42. The external terminals T₁ facilitate connecting the inner and outer coils together or separately. For example, at low currents higher inductance may be needed and at higher currents lower inductance may be needed.

A plurality of outer windings 48 are wrapped on the core 42 including the embedded inner coil 44 to form an outer coil 50. The outer coil 50 is connected by terminals T₂ to the DC/DC Converter 28 module or the power electronics module 26.

The inner coil 44 is wound in the direction of the flux path created by the outside coil 50. The inner coil 44 and the outer coil 50 both utilize the same core 42 resulting in weight savings.

A characteristic of winding the inner coil 44 along the flux path created by the outer winding 48 is that the magnetic field lines due to both the inner and outer windings 46, 48 are perpendicular to each other and are magnetically uncoupled. The two inductors can be operated as separate (independent) inductors or electrically combined together for a desired total inductance (the level of inductance should be within the saturation limits of the core). This arrangement can be particularly useful in applications requiring different inductance values at low and high currents.

The inductive field of the inner coil 44 is disposed along the z-axis and the inductive field of the outer coil 50 is disposed in the x/y-plane. With this arrangement the inductor 40 can provide three different levels of induction. A first level of induction may be provided by the inner coil 42 alone; a second level of induction may be provided by the outer coil 50; and a third level of induction may be provided by coupling the inductive output of the inner coil 42 and the outer coil 50. The orthogonal magnetic fields generate magnetically uncoupled inductors using a single core, which can be operated independently or electrically connected suitably to achieve a required value of effective inductance.

One example of an inductor made according to this disclosure has the following specification:

### Core:

| | |
|---|---|
| Inner Diameter | 1 inch |
| Outer diameter | 6 inches |
| Height | 2.5 inches |
| Relative permeability of the core 50 μr | |

### Outer Winding:

20 Turns
Copper (εr = 1, μr = 0.999991,σ = 58 × 10⁶ s/m, mass density = 8933)

| | |
|---|---|
| Radius of the wire | 1.365 mm |

### Inner Winding

| 5 TURNS (at 5 inch diameter portion of the core) | |
|---|---|
| Copper (εr = 1, μr = 0.999991,σ = 58 × 10⁶ s/m, | |
| mass density = 8933) | |
| Radius of the wire | 1.365 mm |

The simulation results for winding dc resistance (Rdc) and dc inductance (Ldc) for the three cases are shown in the tables below. For case 3, in addition to the self-inductances of the two windings, the mutual inductance values are also shown since both windings are excited simultaneously. Saturation effects and core losses have been ignored for simplicity.

Case 1: Only outside winding is excited by 1 A, inner winding kept open

| | |
|---|---|
| Rdc (mΩ) | 21.3 |
| Ldc (μH) | 455.3 |

Case 2: Only inside winding is excited by 1 A, outer winding kept open

| | |
|---|---|
| Rdc (mΩ) | 8.5 |
| Ldc (μH) | 135.6 |

| Case 3: Both inside and outside windings are connected in series | |
|---|---|
| and excited | |
| Rdc (mΩ) | 29.6 |
| Self Ldc (pH) | 589.4 |
| Rdc (mΩ) | 0.01 |
| Mutual Ldc (μH) | −0.9 |

The mutual inductance in the above three cases is very negligible compared to the self-inductance values, verifying the negligible magnetic coupling between the two windings.

Referring to FIGS. 5 and 6, another embodiment of an inductor 60 is illustrated that has an inductor structure that consists of three independent inductors and utilizes the uncoupled magnetic field concept in three dimensions to result in mutually perpendicular magnetic fields in all the three directions (x, y and z) as illustrated in the graph of FIG. 6. As shown in FIG. 5, each inductor's magnetic field is confined only to one of the planes in the three dimensions (x, y and z).

Referring to FIG. 5, the inductor 60 includes first, second and third induction coils (62, 64, and 66). The induction coils are wound on a core 68 including three portions. The three portions of the core may also be referred to as a first core loop 70 lying in a x/y plane, a second core loop 72 lying in a y/z plane, and a third core loop 74 lying in a x/z plane.

The first core loop 70 of the core 68 has a first shared leg 76 lying on the x-axis and a second shared leg 78 lying on the y-axis. The first core loop 70 has a first linking portion 80 in the x/y plane between distal ends of the first and second shared legs 76, 78. The second core loop 72 includes the second shared leg 78 lying on the y-axis and a third shared leg 82 lying on the z-axis. The second core loop 72 has a second linking portion 84 in a y/z plane between distal ends of the second and third shared legs 78, 82. The third core loop 74 includes the first shared leg 76 lying on the x-axis and the third shared leg 82 lying on the z-axis. The third core loop 74 has a third linking portion 86 in a x/z plane between distal ends of the first and the third shared legs 76, 82. The x-axis, the y-axis, and z-axis extend from a common origin point “O.”

The first induction coil 62, or winding, is wrapped around the first and second shared legs 76,78 and the first linking portion 80. The second induction coil 64, or winding, is wrapped around the second and third shared legs 78, 82 and the second linking portion 84. The third induction coil 66, or winding, is wrapped around the first and third shared legs 76, 82 and the third linking portion 86. Each winding is wound on two shared legs on the axis common to adjacent legs.

The first, second and third induction coils (62, 64, and 66) are selectively provided with current via terminals T₁, T₂, and T₃ to create magnetic fields disposed within the planes of the first, second, and third portions of the core. The first core loop 70 creates an x/y magnetic field when current is provided to the first winding. The second core loop 72 creates a y/z magnetic field when current is provided to the second winding. The third core loop 74 creates an x/z magnetic field when current is provided to the third winding.

The induction coils may be provided with current separately or combined in series or parallel. Induction coils 60 and 69 are capable of providing from one to seven levels of induction. Three levels of induction can be provided by applying current to the coils individually. Three other levels of induction can be provided by applying current to each pair of coils and a seventh level of induction can be provided by connecting all the coils together.

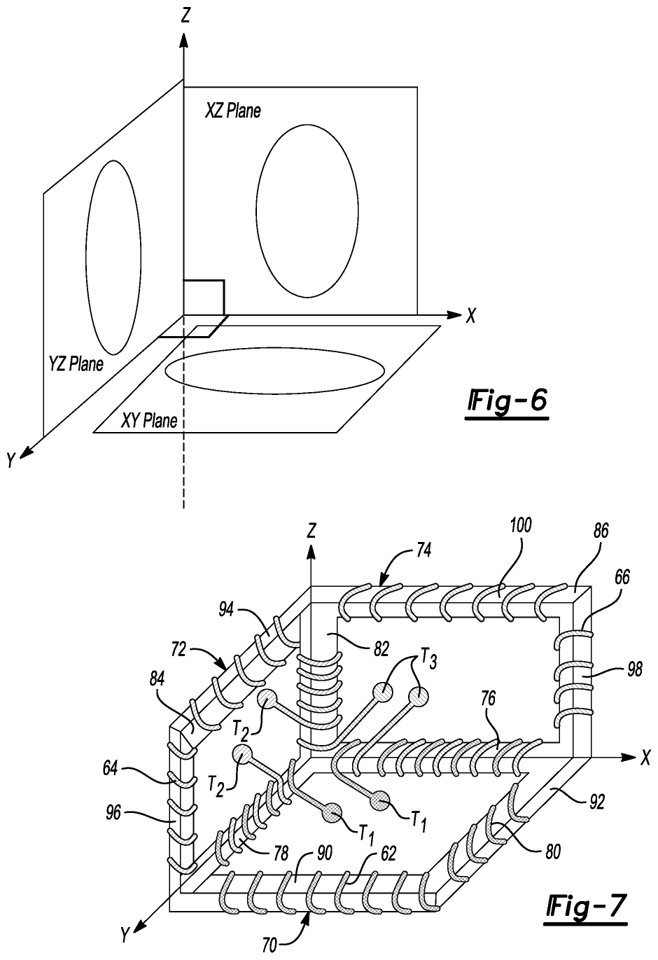

Referring to FIG. 7, another embodiment of an inductor 69 is illustrated that has substantially similar core loops 70, 72 and 74 and induction coils 62, 64 and 66 to those shown in FIG. 5 and, for brevity, the same reference numerals are carried over in reference to the same elements in FIG. 7. The description of the induction coils 62, 64 and 66 nd core loops 70, 72 and 74 having shared legs 76, 78, and 82 above with reference to FIG. 5 is the same for FIG. 7 and is incorporated by reference. The principal difference is that FIG. 5 has arcuate linking portions 80, 84 and 86 while FIG. 7 has linking portions as described below.

In the embodiment of FIG. 7, the first linking portion 80 includes a first leg 90 extending in the x-direction and a second leg 92 extending in the y-direction. The second linking portion 84 includes a first leg 94 extending in the y-direction and a second leg 96 extending in the z-direction. The third linking portion 86 includes a first leg 98 extending in the z-direction and a second leg 100 extending in the x-direction. The first and second legs 90 through 100 are referred to as being rectilinear in that they extend linearly. One or more rectilinear legs may be used to complete the respective loops.

The first core loop 70 includes the first pair of terminals T₁. The second core loop 72 includes the second pair of terminals T₂. The third core loop 74 includes the third pair of terminals T₃. Each pair of terminals are operatively connected to a control circuit 108 that switches current on and off for each induction coil 62, 64 and 66 separately or combined in series or parallel. The control circuit 108 connects and disconnects the supply of current to the inductor coils 62, 64 and 66.

The function of the inductor 69, shown in FIG. 7, is essentially the same as inductor 60, shown in FIG. 5.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. An inductor apparatus comprising:
a core formed of a ferromagnetic powder material in a one-piece toroidal shape;
an inner coil winding disposed in an x/y plane within the core and embedded within the powder material; and
an outer coil winding wrapped around the outside of the core with windings being radially wrapped around the core.

2. The inductor apparatus of claim 1 wherein the inner coil creates a magnetic field vector along a z-axis when current is supplied to the inner coil.

3. The inductor apparatus of claim 1 wherein the outer coil creates a circular magnetic field in an x/y plane when current is supplied to the outer coil.

4. The inductor apparatus of claim 1 wherein the inner coil is disposed in an x/y plane and creates a magnetic field along a z-axis when current is supplied to the inner coil, and wherein the outer coil creates a circular magnetic field in the x/y plane when current is supplied to the outer coil.

5. The inductor apparatus of claim 1 wherein the core has a polygonal radial section.

6. The inductor apparatus of claim 1 wherein the core has a circular radial section.

7. The inductor apparatus of claim 1 wherein the inner coil winding is connected to a first pair of terminals disposed outside of the core, and the outer coil winding is connected to a second pair of terminals, wherein the inner coil winding and the outer coil winding may be provided with current separately or combined in series or in parallel.

8. An inductor apparatus comprising:
a core including a first core loop lying in a x/y plane, a second core loop lying in a y/z plane, and a third core loop lying in a x/z plane, wherein the x/y plane, the y/z plane, and the x/z plane have a common origin point;
a first winding around the first core loop for creating an x/y magnetic field when current is provided to the first winding:
a second winding around the second core loop for creating a y/z magnetic field when current is provided to the second winding; and
a third winding around the third core loop for creating an x/z magnetic field when current is provided to the third winding.

9. The inductor apparatus of claim 8 wherein the first core loop includes a first shared leg lying on an x-axis and a second shared leg lying on a y-axis, the second core loop includes the second shared leg lying on the y-axis and a third shared leg lying on a z-axis, and the third core loop includes the first shared leg lying on the x-axis and the third shared leg lying on the z-axis.

10. The inductor apparatus of claim 9 wherein the first core loop includes a first linking portion extending in an x/y plane between distal ends of the first and second shared legs, the second core loop includes a second linking portion extending in an y/z plane between distal ends of the second and third legs, and the third core loop includes a third linking portion extending in an x/z plane between distal ends of the first and third legs.

11. The inductor apparatus of claim 10 wherein the first linking portion, second linking portion and third linking portions are arcuate.

12. The inductor apparatus of claim 10 wherein the first linking portion, second linking portion and third linking portion form the first, second and third core loops into rectilinear shapes.

13. An inductor apparatus comprising:
a core including—
a first portion having a first shared leg lying on an x-axis, a second shared leg lying on a y-axis, and a first linking portion extending in an x/y plane between distal ends of the first and second legs;
a second portion including the second shared leg lying on a y-axis and a third shared leg lying on a z-axis, a second linking portion extending in a y/z plane between distal ends of the second and third shared legs, and
a third portion including the first shared leg lying on the x-axis and the third shared leg lying on the z-axis, a third linking portion extending in a x/z plane between distal ends of the first and third shared legs; and wherein the x-axis, the y-axis, and z-axis extend from a common origin point; and
a first winding wrapped around the first portion and the first linking portion;
a second winding wrapped around the second portion and the second linking portion; and
a third winding wrapped around the third portion and the third linking portion, wherein the windings are selectively provided with current to create a magnetic field in the planes within which the first, second, and third portions lie, wherein the windings may be provided with current separately or combined in series or parallel.

14. The inductor apparatus of claim 13 wherein the first linking portion, second linking portion and third linking portions are arcuate.

15. The inductor apparatus of claim 13 wherein the first linking portion, second linking portion and third linking portion form rectilinear first, second, and third core loops into rectilinear shapes.

16. The inductor apparatus of claim 13 wherein the core is a ferromagnetic powder core.

17. The inductor apparatus of claim 13 wherein the core is a laminated core.
